(19) United States
(12) Patent Application Publication
(10) Pub. No.: US 2008/0133820 A1
(43) Pub. Date: Jun. 5, 2008

(54) DDR flash implementation with row buffer interface to legacy flash functions

(76) Inventors: Ramkarthik Ganesan, Folsom, CA (US); Saad Monasa, Sacramento, CA (US); William Low, Vancouver (CA)

Correspondence Address: INTEL CORPORATION;c/o INTELLEVATE, LLC, P.O. BOX 52050, MINNEAPOLIS, MN, 55402, US

(21) Appl. No.: 11/607,556

(22) Filed: Nov. 30, 2006

(51) Int. Cl. G06F 12/00

(52) U.S. Cl. 711/103; 711/E12.001

(57) ABSTRACT

A DDR non-volatile memory providing Double Data Rate (DDR) operation by decoding an address received from an external processor at a DDR interface to provide a command to store data in page buffers. The data received from the external processor at the DDR interface is transferred to page buffers based on the command. A command issued by an internal microcontroller transfers data stored in the page buffers to non-volatile storage.

Recent developments in a number of different digital technologies have greatly increased the need to transfer large amounts of data from one device to another or across a network to another system. Technological developments permit digitization and compression of large amounts of voice, video, imaging, and data information, which may be rapidly transmitted from computers and other digital equipment to other devices within the network. Computers have faster central processing units and substantially increased memory capabilities, which have increased the demand for devices that can more quickly store and transfer larger amounts of data.

These developments in digital technology have stimulated a need to deliver ever faster storage devices to supply data to these processing units. Double Data Rate (DDR) SDRAM included in main memories for computing systems provides improvements in performance but does not provide permanent storage. Further improvements in faster, permanent data storage are needed.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram that illustrates a wireless device and a Double Data Rate (DDR) nonvolatile memory implementation with a row buffer interface to legacy flash functions in accordance with the present invention;

FIG. 2 is a diagram that illustrates an embodiment of the DDR nonvolatile memory in accordance with the present invention; and

FIG. 3 is a flow diagram that illustrates a method of a host processor interfacing to the DDR nonvolatile memory.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

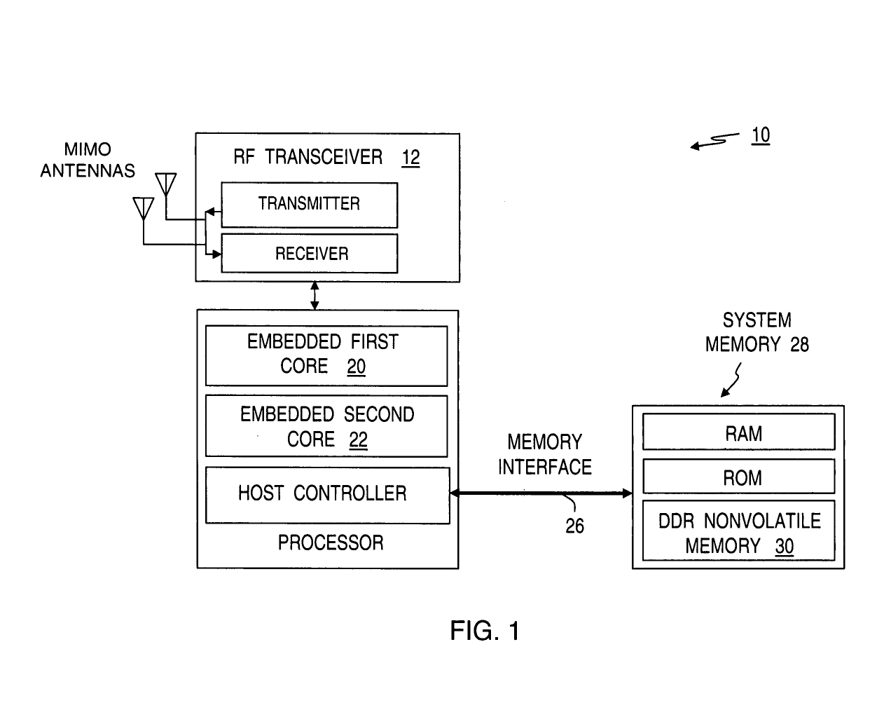

As shown in FIG. 1, the embodiment illustrates a device 10 as a wireless communications device that includes a radio to allow communication with other devices. Accordingly, communications device 10 may operate in a wireless network and be any type of device capable of communicating in an RF/location space with another device. However, it should be pointed out that device 10 is not limited to wireless embodiments and the present invention may have applications in a variety of products. For instance, the claimed subject matter may be incorporated into desktop computers, laptops, smart phones, MP3 players, cameras, communicators and Personal Digital Assistants (PDAs), medical or biotech equipment, automotive safety and protective equipment, automotive infotainment products, etc. However, it should be understood that the scope of the present invention is not limited to these examples.

The figure illustrates the wireless embodiment where a transceiver 12 receives and transmits a modulated signal from multiple antennas, although this is not limiting to the present invention. Analog front end transceiver 12 may be a stand-alone Radio Frequency (RF) discrete or integrated analog circuit, or alternatively, transceiver 12 may be embedded with a processor as a mixed-mode integrated circuit. The processor, in general, processes functions that fetch instructions, generate decodes, find operands, and perform appropriate actions, then stores results. The processor may include baseband and applications processing functions and utilize one or more processor cores to handle application functions and allow processing workloads to be shared across the cores.

The processor may transfer data through an interface 26 to a system memory 28 that may include a combination of memories such as a Random Access Memory (RAM), a Read Only Memory (ROM) and a nonvolatile memory, although neither the type of memory, variety of memories, nor combination of memories included in system memory 28 is a limitation of the present invention. Nonvolatile memory 26 may be a memory such as, for example, an ETOX™ Flash NOR Memory, an Electrically Erasable and Programmable Read Only Memory (EEPROM), a Ferroelectric Random Access Memory (FRAM), a Polymer Ferroelectric Random Access Memory (PFRAM), a Magnetic Random Access Memory (MRAM), an Ovonics Unified Memory (OUM), or any other device capable of storing instructions and/or data and retaining that information even with device 10 in a power conservation mode. However, it should be understood that the scope of the present invention is not limited to these examples for a nonvolatile memory.

In accordance with the present invention the architecture of device 10 includes a Double Data Rate (DDR) nonvolatile memory 30 as a high-bandwidth technology that supports data transfers on both the rising and falling edges of each clock cycle. The clock signal transitions from “0” to “1” and back to “0” each cycle with the first transition called the “rising edge” and the second transition the “falling edge”. Normally only one of these clock signal transitions is used to trigger a data transfer but with DDR nonvolatile memory 30 both clock edges are used, effectively doubling the memory's bandwidth by transferring data twice per clock signal. Again, in accordance with the present invention the DDR nonvolatile memory 30 architecture accommodates legacy flash functions while implementing DDR behavior.

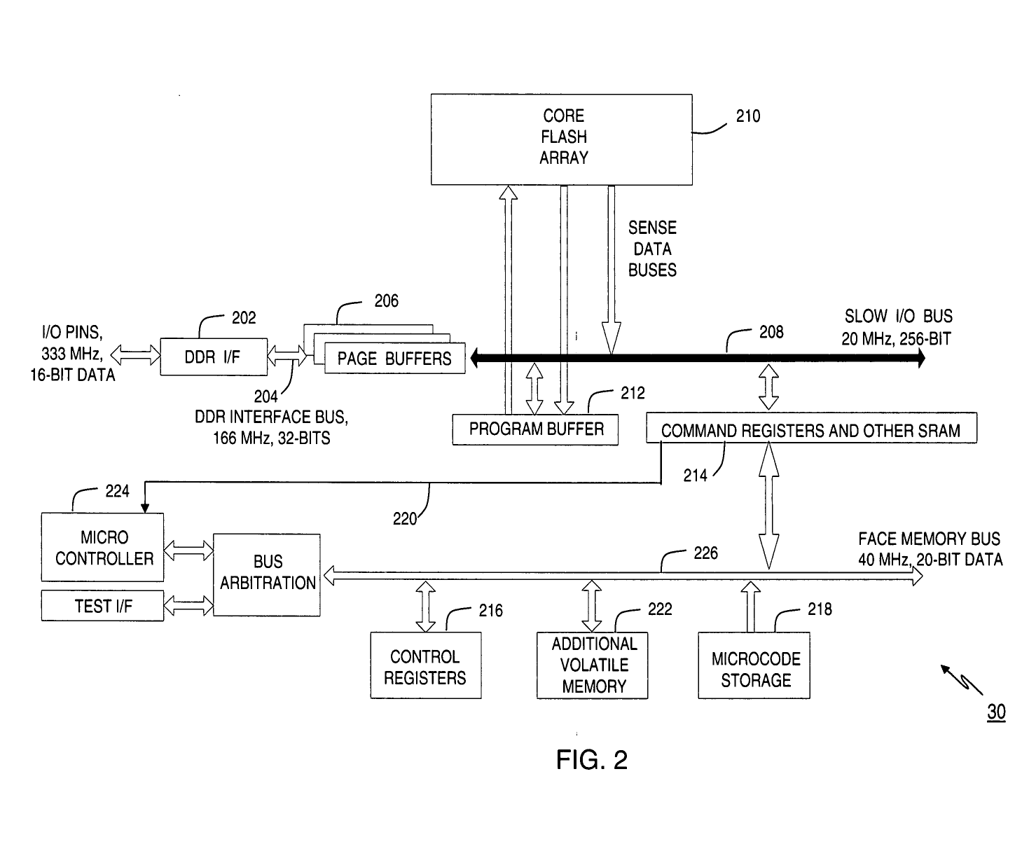

FIG. 2 is a block diagram that illustrates an embodiment of the present invention for DDR nonvolatile memory 30. A DDR I/F block 202 provides an interface between the host processor and other memory blocks such as the memory arrays, registers and microcontroller. DDR I/F block 202 is designed to transfer two data words per clock cycle at the I/O pins for a single read access of the DDR nonvolatile memory 30. The row buffers in multiple page buffers 206 are connected to DDR I/F block 202 via a DDR interface bus 204 to transfer 32-bits operating at 166 MHz. Thus, the row buffers isolate the host processes from the internal flash blocks operating within DDR nonvolatile memory 30.

Data transferred to these row buffers located in page buffers 206 is burst out to the system based on a clock. Flash specific information and array data may be transferred to the row buffers based on an active command similar to DDR protocol (JEDEC definition). Thus, an active command as detected and decoded by DDR I/F 202 triggers an internal array sense operation for core flash array 210. The data accessed by the active command is stored in one of the row buffers and burst out after specific latencies through DDR I/F 202 during a read command.

As illustrated in the figure, arrayed data stored in core flash array 210 may be sensed and transferred to the I/O bus 208. I/O bus 208 transfers 256-bits of data/information at the 20 MHz frequency to the multiple page buffers 206 where data is held for burst reads. Thus, the DDR I/F block 202 transfers the page buffer data to the host processor system at both edges of the system clock, converting the 256 bit single edged data within the flash device to a 16 bit double edged data to the host processor system.

Also as illustrated in the figure, various registers in DDR nonvolatile memory 30 that store non-array data may be read through the interface that includes the row buffers, i.e., page buffers 206. I/O bus 208 connects page buffers 206 with both the program buffer 212 and the registers and other SRAM block 214 for transferring the data stored in these non-array components to the row buffer and providing access directly during the DDR burst protocol. Thus, an active command issued to a non-array address as decoded by DDR I/F 202 is used to transfer the non-array data to the row buffer where that data may be burst out to the host processor system. Note that even through the non-array data may change over time depending on the activities being performed in the background by DDR nonvolatile memory 30, regular refreshes of the non-array data to the row buffer to ensure the integrity of the data may be scheduled using an internal synchronization scheme.

Writing to DDR nonvolatile memory 30 involves two steps to store data in the internal volatile registers. The data received by DDR I/F 202 in a write operation is transferred through page buffers 206 to eventually be stored in the non-volatile storage as directed by an internal microcontroller 224. Thus, a first step in the write operation writes data from DDR I/F 202 to page buffers 206. A second step transfers that stored data to I/O bus 208 for storage in the non-volatile storage registers.

In one embodiment closing the row buffers of page buffers 20 triggers the transfer of the stored data to the register destination. In this embodiment microcontroller 224 issues a command that results in data storage to the eventual non-volatile registers. The command may or may not manipulate data prior to storage. Note that the bus transfer speed for I/O bus 208 corresponds to the buffer closure latency to ensure that subsequent operations are not interrupted.

Alternatively, another embodiment includes automated data transfer (synchronization) between the row buffer and the non-volatile registers where the data belongs. This embodiment may use an internal state machine (not shown) to inhibit conflicts between external data writes and internal data transfers.

Note that microcontroller 224 may manage complex memory operations internal to DDR nonvolatile memory 30 without intervention from the host processor. Microcontroller 224 may access program code from microcode storage 218 and receive data needed for operations through memory bus 226. Program buffer data stored in program buffer 212 may be accessed by microcontroller 224 to initiate the nonvolatile memory array program operation. Microcontroller 224 may use memory bus 226 to update status bits in the status register of control registers 216. Status bits may be burst out of the status register through page buffers 206 and the DDR I/F block 202 on a host processor system request.

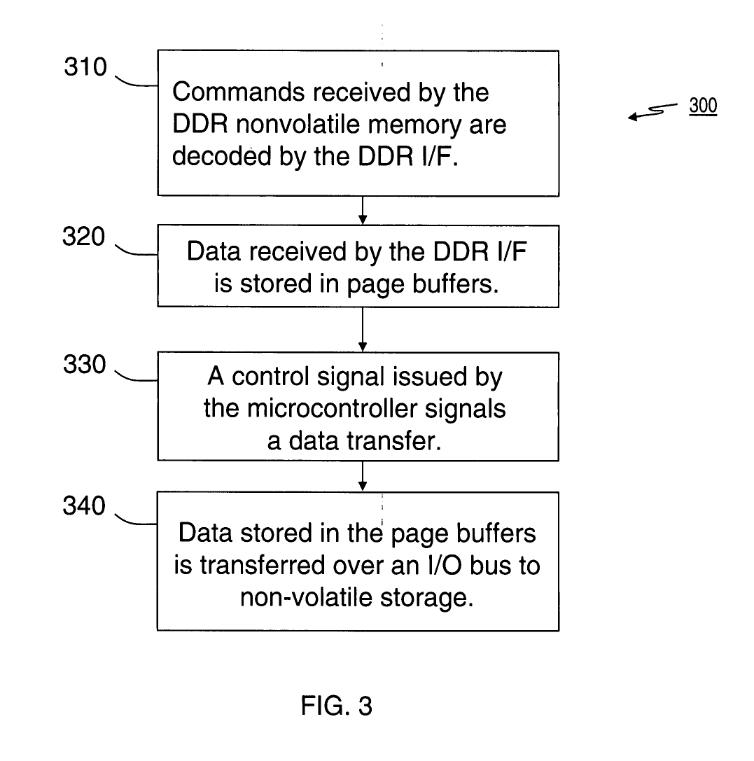

FIG. 3 shows a flowchart in accordance with various embodiments of the present invention that illustrates an algorithm or process in accordance with the present invention that may be used to provide a flash memory with DDR behavior. Method 300 or portions thereof are performed by the processor/flash device combination of an electronic system. Method 300 is not limited by the particular type of apparatus, software element, or system performing the method. Also, the various actions in method 300 may be performed in the order presented, or may be performed in a different order.

Method 300 is shown beginning at block 310 for an operation where commands are received by DDR nonvolatile memory 30 and decoded by DDR I/F 202. Block 320 indicates an operation to store data in page buffers 206. In block 330 an operation is described where a control signal issued by microcontroller 224 initiates a data transfer. In block 340 the operation includes transferring data stored in page buffers 206 over I/O bus 208 to store in non-volatile storage. Thus, a signal issued by microcontroller 224 controls the data transfers from page buffers 206 through the I/O bus 208 and the eventual storage in the non-volatile registers.

Note that the architecture and operating methods within DDR nonvolatile memory 30 involve a speed path that is limited to the buffer and the I/O ring. The internal registers and flash specific operations operate at 20 MHz and 40 MHz speeds do not operate at the DDR speeds. By reducing the total load on the fast DDR bus, higher performance (e.g. 333 MHz vs. 266 MHz) for the DDR nonvolatile memory may be achieved.

By now it should be apparent that a DDR nonvolatile memory has been presented with page buffers (row buffers) to store the read data and the write data. The data from the page buffers is burst out via the DDR interface at 333 MHz speeds. Reading and writing data from the page buffers to the I/O bus is synchronized with the 20 MHz clock as compared to the 166 MHz operation of the DDR interface. Thus, synchronization is achieved for data transfers between the registers (labeled as program and other command registers) and the page buffers. The array data in transferred based on a specific DDR command (active command).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A non-volatile memory having storage, comprising:
a Double Data Rate (DDR) interface block to receive from an external processor data and an address to decode as a command;
page buffers to store the data received through the DDR interface block in response to the command from the DDR interface block; and
a microcontroller internal to the non-volatile memory to issue a command to transfer the data stored in the page buffers to the non-volatile storage.

2. The non-volatile memory of claim 1 wherein two data words per clock cycle are provided at I/O pins for a write of the DDR nonvolatile memory.

3. The non-volatile memory of claim 2 wherein the DDR interface block receives data at a frequency of 333 MHz at the I/O pins and transfers the data to from the DDR interface block to the page buffers at a frequency of 166 MHz.

4. The non-volatile memory of claim 3 wherein the data stored in the page buffers is transferred on an internal I/O bus at a frequency of 20 MHz to the non-volatile storage.

5. A method of providing Double Data Rate (DDR) operation in a DDR non-volatile memory; comprising:
decoding an address received from an external processor at a DDR interface to provide a command to store data in page buffers;
transferring data received from the external processor at the DDR interface to page buffers based on the command; and
issuing a command by an internal microcontroller to transfer data stored in the page buffers to non-volatile storage.

6. The method of claim 5 further including three buses operating at different frequencies, including:
operating a first bus at I/O pins of the DDR non-volatile memory at 333 MHz;
operating a second bus between the DDR interface and the page buffers at 166 MHz; and
operating a third bus at an output of the page buffers at 20 MHz.

7. The method of claim 6 further including connecting a core flash array to the third bus.

8. The method of claim 6 further including connecting a program buffer to the third bus.

9. The method of claim 6 further including connecting a command registers to the third bus.

10. The method of claim 6 wherein the first bus at the I/O pins has two data words per clock cycle for a write of the DDR nonvolatile memory.

11. The method of claim 6 wherein the second bus between the DDR interface and the page buffers has one data word per clock cycle.

12. A Double Data Rate (DDR) non-volatile memory, comprising:
a DDR interface block to transfer two data words per clock cycle at external pins;
page buffers directly coupled to the DDR interface block to receive the data words; and
an I/O bus coupled to the page buffers to transfer data to non-volatile storage locations within the DDR non-volatile memory.

13. The DDR non-volatile memory of claim 12 further including connecting a core flash array, a program buffer and command registers to the I/O bus.

14. The DDR non-volatile memory of claim 12 wherein the data words received by the DDR interface block at the external pins are 16 bit data words and the data words received by the page buffers are 32 bit data words.

15. A method comprising:
issuing an active command to a non-array address as decoded by a DDR I/F of a DDR non-volatile memory;
using a decoded command to transfer non-array data to page buffers; and
bursting the non-array data to a host processor system.

16. The method of claim 15 further comprising:
scheduling a refresh of the non-array data to the page buffers using an internal synchronization scheme to ensure integrity of the non-array data.

17. The method of claim 16 further comprising:
maintaining data coherency by transferring the non-array data stored in the page buffer to internal program buffers.

18. The method of claim 16 further comprising:
maintaining data coherency by transferring the non-array data stored in the page buffer to a Static Random Access Memory (SRAM).
